(19) United States
(12) Patent Application Publication
(10) Pub. No.: US 2009/0076888 A1
(43) Pub. Date: Mar. 19, 2009

(54) METHOD AND SYSTEM FOR EVALUATING RETAIL AND RELATED REAL ESTATE DEVELOPMENT OPPORTUNITIES

(76) Inventors: MARK OSTER, URBANDALE, IA (US); JEROME D. OSTER, ANKENY, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/207,929

(22) Filed: Sep. 10, 2008

Related U.S. Application Data
(60) Provisional application No. 60/972,373, filed on Sep. 14, 2007.

(51) Int. Cl. G06Q 10/00; G06Q 50/00

(52) U.S. Cl. 705/10

(57) ABSTRACT

Potential retail or related real estate development sites are identified using computer databases and algorithms to derive normative association between the supply and demand characteristics of certain trade areas. For a particular site location, the method identifies the most suitable square footage amount for retail or related real estate development. For a particular shopping center, the method identifies individual tenants that are most suitable for inclusion at the particular location. Further, in another embodiment there is provided a method which identifies existing facilities in the nation or region that are most analogous thereby providing a means of forecasting sales for new real estate development.

### CROSS-REFERENCE TO RELATED APPLICATIONS

This application claims priority under 35 U.S.C. § 119 of a provisional application Ser. No. 60/972,373 filed Sep. 14, 2007, which application is hereby incorporated by reference in its entirety.

### FIELD OF THE INVENTION

The present invention broadly relates to the field of identifying potential retail or related real estate development sites using computer databases and algorithms to derive normative association between the supply and demand characteristics of certain trade areas.

### BACKGROUND OF THE INVENTION

Currently, methods are available to assess retail or related real estate development using trade area profiles for a developer's property. These methods include the use of geographic information systems (“GIS”) which use interactive computer maps which display demographic and competitive information that is obtained from a variety of databases and allows for supply versus demand visualization. Using GIS, a potential development location can be compared with a retailer's or business' existing locations (analogs) for which sales data or other data is available, thereby evaluating new potential development locations. One methodology that has evolved parallel with GIS is “gravity modeling.” Originally this methodology was applied to transportation planning, but later used in the food industry and for general merchandise retail. Gravity modeling addresses marketplace supply versus demand conditions referred to as “horizontal factors.” Examples of horizontal factors include mass, distance, travel patterns, and movement. However, gravity modeling does not address ways in which a particular marketplace is part of a larger whole, in essence, the “vertical” network which links supply versus demand conditions in one area to all other areas nationally; that is, linking the micro and macro scales in which one indicator becomes normative for determining implications for other factors. To address this, correlation and regression modeling has been employed which draws on macro-scale analysis of the association between trade area income and output data (i.e. sales data) of a retail store or related real estate. This macro-scale analysis can then be used to derive micro-scale predictions. So far, however, correlation and regression models have not been able to successfully address the dimension that gravity modeling addresses, in effect, it is blind to causal factors having to do with marketplace supply versus demand.

Further, other methods determine potential development based on either supply or demand of retail or related real estate in a certain area. What is missing is the analysis based on specific demographics of a geographic region and adjacent existing retail or related real estate locations to assess supply, and the objective differences in demand within the same geographic region based on a minimum threshold of household income or other economic indicators. The prior art methods base retail or related real estate development on industry experience rather than on specific data and demographics for the particular site to be developed. Past and current methods do not identify the potential oversupply or undersupply of retail or related real estate in a geographic area as it relates to the economic base for supporting the related market as indicated by household income or other economic and demographic factors. As for the analysis of identifying a prospective retail tenant or other category of business for a particular geographic site, the current methods do not use specific demographics of the same named retailer or business entity at other locations with respect to the location of same or competing stores or business entities within the near geographic area.

As a result, the standard “toolbox” to analyze potential development sites for retail and related real estate consists of strictly GIS display methods, analog-based methods, gravity-based methods, and correlation/regression-based methods—or some variants thereof. None of these tools address the full scope of the problem at hand, a location's actual versus normative status regarding supply versus demand conditions by category of retail store or related real estate to systematically and objectively evaluate opportunities to develop new retail stores or businesses at a specific location.

Accordingly, one object of the invention is to determine the supply of retail or related real estate in a geographic region using data related to existing locations of retail shops or related real estate and the demand for retail shop space or related real estate in the same geographic region based on affluent households or other population characteristics. The difference between the supply and demand in the geographic region for retail or related real estate identifies potential development sites, which have the economic and demographic base to support the development.

A further object of the invention is to determine supply of retail or related real estate using existing locations of retail and related real estate, distance between like retail and related real estate, and brand or drawing power of the retail shops and related real estate.

Another object of the invention is to calculate the adjusted quality index or drawing power of each retail store or related real estate located in the geographic region by utilizing a quality index for each named retailer and related real estate, and adjusting the quality index by a distance factor from the existing retail store or related real estate location to the prospective new location.

Another object of the invention is to determine demand of retail or related real estate in a geographic region by determining the number of affluent households or other population characteristics and economic factors within a certain distance of the potential development site.

Another object of the invention is to use either regional or national normative values of retail or related real estate to compare the calculated delta between supply and demand of retail or related real estate in a geographic region to identify geographic sites which will economically and demographically support new retail or related real estate development.

A further object of the invention is to determine the suitability for locating a particular retail tenant or business at a specific site using store population characteristics of the same retailers or business entities in different geographic areas and population characteristics surrounding the prospective site location.

Another object of the invention is to create a database of existing retail store locations or related business entities by specific name which includes location, number of locations, distance to sister stores and same or similar business entities and competitive markets, population characteristics for each store or business location such as surrounding population, average household income, affluent households, etc.

Another object of the invention is to determine the population, household income and other population characteristics surrounding the new site for the prospective retail or related real estate entity.

Another object of the invention is to prepare a report showing the population characteristics for the prospective retail or related real estate entity.

Another object of the invention is to compare the population characteristics of the prospective retail or related real estate entity to the surrounding population and population characteristics.

Another object of the invention is to use an analog method for identifying existing retail developments selected according to population characteristics and retail supply conditions of existing retail developments within the geographic region or nationally.

### SUMMARY OF THE INVENTION

The present invention provides a method and system using computer databases and algorithms to derive the supply of retail at specific sites and the demand characteristics of the trade areas for evaluating development opportunities for retail stores, shopping centers, restaurants, etc. The method and system uses a database of the particular type of retail to be examined and the characteristics of its trade area. A geographic point is selected within a region for analysis. Within the region surrounding the geographic point, the supply of retail is determined using a variety of indices appropriate to the particular retailer or retail type. Demand for a particular retailer or retail type surrounding the identified geographic point is determined using a variety of factors, such as the number of affluent households or other economic indicator. Different indicators or a stratification of an indicator may also be used to determine demand. The mapping of the supply and demand patterns results in the identification of relative strengths of the prospective development sites.

The present invention also describes a method for determining a prospective retail or related real estate tenant for a geographic site. In this aspect of the invention, a geographic site is predetermined. A prospective tenant, retail or related real estate, is identified for the site. The demographic data of the same named tenants in the retailer's chain is compared with the population characteristics of the proposed geographic site. Analysis is conducted to determine if the profile of the geographic site's population characteristics falls within acceptable ranges for the same named tenants as that of the prospective tenant for the site. This analysis assesses the economic potential of locating the prospective tenant at that specific geographic site based on population characteristics and distance comparisons.

### BRIEF DESCRIPTION OF THE DRAWINGS

FIG. 1 shows a flow chart depicting the method and system for use of computer databases and algorithms for evaluation of real estate development opportunities.

FIG. 2 shows the detail of the method and system depicted in FIG. 1.

FIG. 3 shows an example of a geographic area's supply of fashion retail.

FIG. 4 shows fashion related demand numbers of affluent households defined as great than $100,000 annual income aggregated by an 8-mile radius.

FIG. 5 shows the mapping of the resulting retail or related retail supply versus demand pattern.

FIG. 6 shows a tenant opportunity summary for a particular site.

FIG. 7 shows a tenant suitability summary for a particular site.

FIG. 8 shows tenant mix recommendations for a particular site.

FIG. 9 shows existing retail centers that have trade areas that are similar with respect to their populations and affluent households.

FIG. 10 shows trade area fashion scores or trade area quality indices plotted against affluent households.

### DETAILED DESCRIPTION

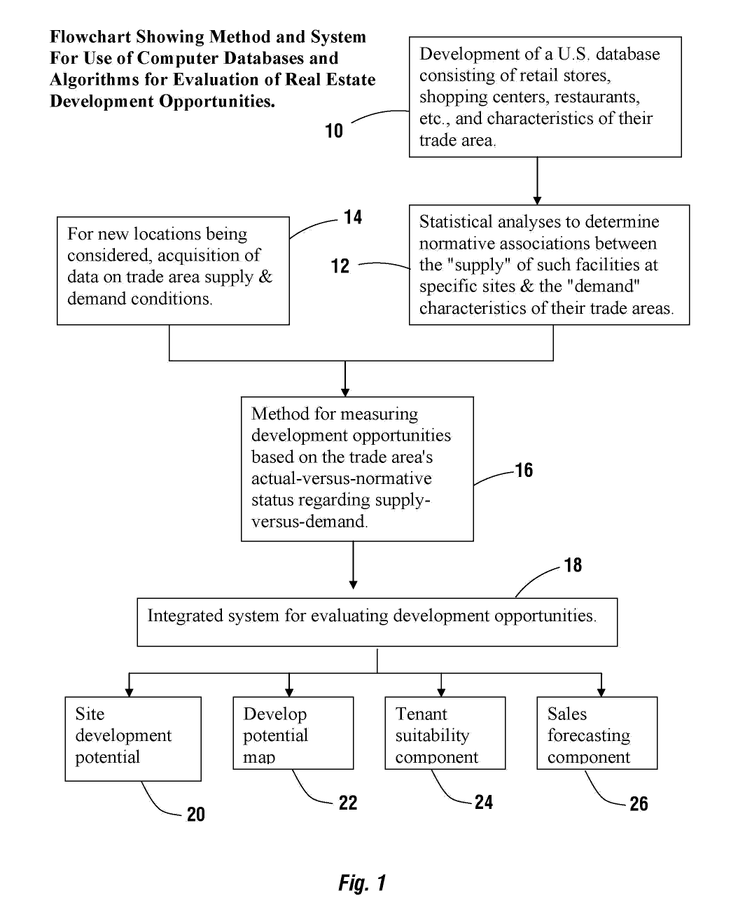

The method and system using computer databases and algorithms for evaluation of real estate development opportunities in accordance with the present invention is shown generally in FIG. 1. This method and system derives normative associations between the supply of retail at specific sites and the demand characteristics of the trade areas in which the sites are located. Thus, the actual-versus-normative status of any site with respect to supply-versus-demand conditions within its trade area can be empirically ascertained.

This comparative method is extensible to a variety of related real estate development issues and comprises an integrated system. For a particular category of retail or related real estate, the system identifies optimal locations for development within any metropolitan or other area. For a particular site location, the system identifies the most suitable square footage amount of retail or related real estate development. For a particular shopping center, the system identifies individual tenants that are most suitable for inclusion at that location. Additionally, the system identifies existing facilities in the nation or region that are most analogous, based on multi-dimensional location similarities, thereby providing a means of forecasting the sales of a shopping center, retail store, or other new real estate development being considered. Retail may be any type of retail store including fashion retail, but is not necessarily limited to fashion retail. Related real estate may be any kind of related real estate such as banks, restaurants, cinemas, health clubs, etc., but is not necessarily limited to those named.

The method and system for evaluating development opportunities generally begins with development of a database of retail stores, shopping centers, restaurants, etc., in the United States, and characteristics of their trade areas 10. This is followed by statistical analyses to determine normative associations between the supply of such facilities at specific sites and the demand characteristics of their trade areas 12. For new locations being considered, data regarding trade area supply and demand conditions must be acquired 14. The development opportunity is based on the trade area's actual-versus-normative status regarding supply-versus-demand 16. This integrated system for evaluating development opportunities 18 includes site development potential 20, development of the potential map 22, tenant suitability component 24, and sales forecasting component 26. Within this normative context, any particular site's opportunities for development can be determined.

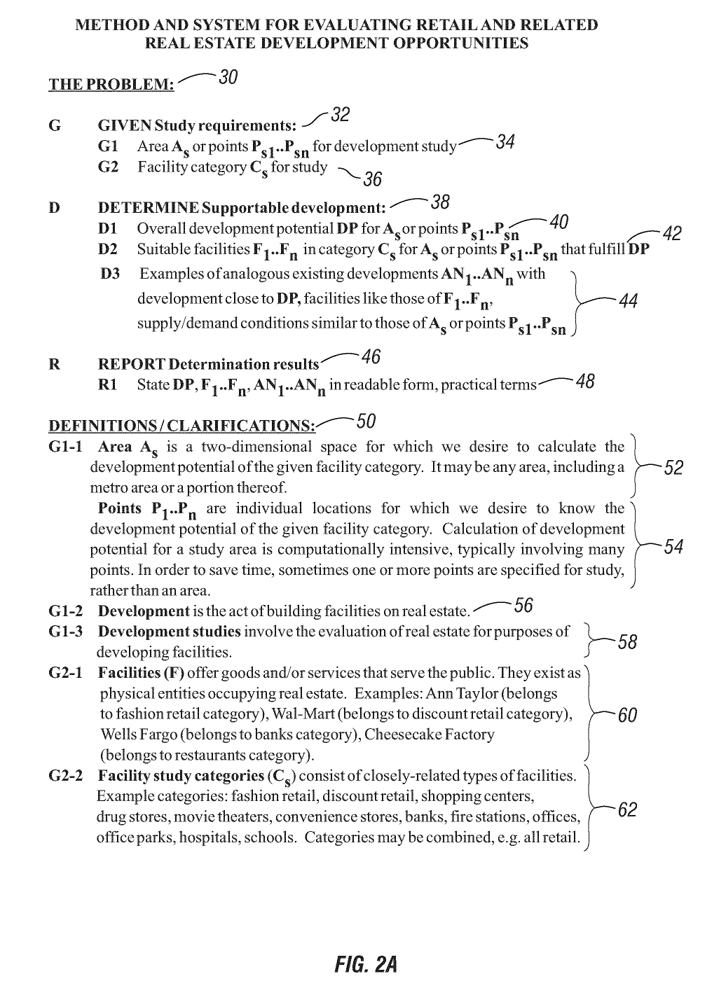

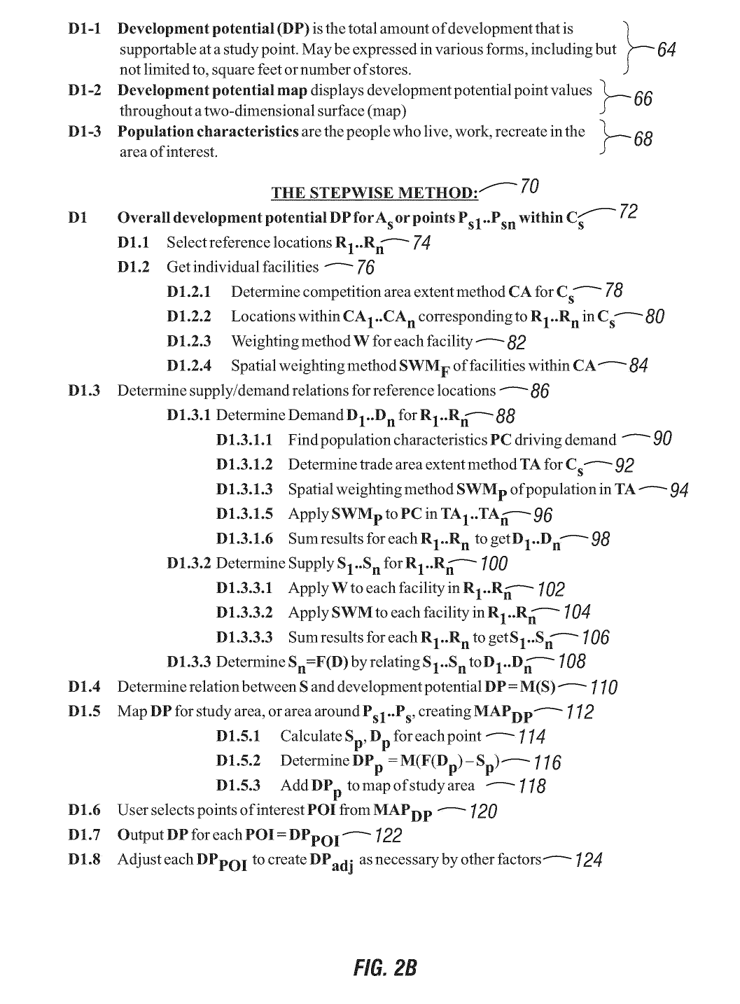

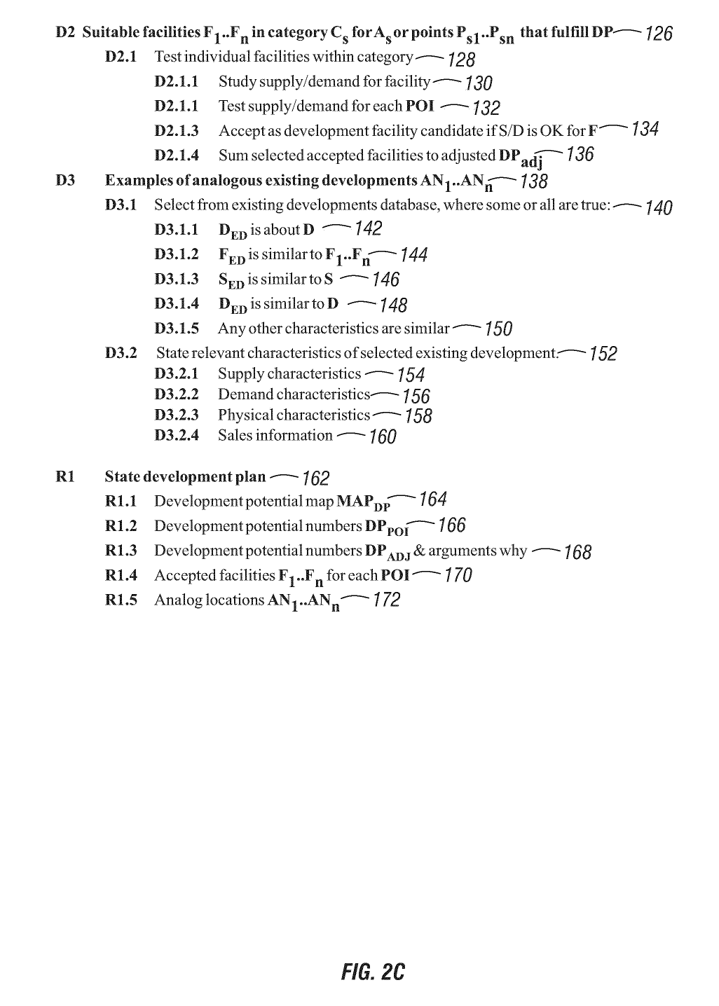

FIG. 2 further specifies by way of example the method and system of the present invention. A problem is presented for analysis 30 along with the given study requirements 32 to include the area or geographic points for development study 34 and the facility category for study 36. Next, supportable development is determined 38 through the overall development potential for the area or geographic point 40, the category of suitable facilities or geographic points that fulfill the development potential 42, examples of analogous existing development with development close to the development potential with retail facilities like those of the suitable facilities, along with the supply and demand conditions similar to those of the area or geographic point 44. A report 46 is generated which states the development potential, of the suitable facilities compared to the examples of analogous existing developments 48.

By way of definition, “area” means a two-dimensional space for which there is desire to calculate the development potential of the given facility category which may be any area, including a metro area or a portion thereof 52. “Point” or “points” means individual locations for which there is desire to know the development potential of the given facility category whereby the calculation of development potential for a study area is computationally intensive, typically involving one or more points rather than an area 54. “Development” means the act of building facilities on real estate 56. “Development studies” means the evaluation of real estate for purposes of developing facilities 58. “Facilities” means offering goods and/or services that serve the public which exist as physical entities occupying real estate 60. “Facility study categories” means closely-related types of facilities, such as fashion retail, discount retail, shopping centers, etc. 62. “Development potential” means the total amount of development that is supportable at a study point and may be expressed in many forms, including but not limited to, square feet or number of stores 64. “Development potential map” means the display of development potential point values throughout a two-dimensional surface (i.e. map) 66. “Population characteristics” means the people who live, work, and recreated in the area of interest 68.

FIG. 2 also describes by way of example the stepwise method 70 for evaluating retail and related real estate development opportunities by determining the overall development potential for an area or geographic point within a facility study category 72. Reference locations are selected 74. Individual retail facilities are identified 76 and the competition area for the identified category of retail facilities is determined 78. The locations within the competition area are identified which correspond to the reference locations in the facility study category 80. Each identified facility is weighted within the context of the competition area, as well as other factors 82, and a spatial weighting method is determined for the facilities within the competition area 84. Next, the supply and demand relationship for the reference locations is determined 86. Demand for the reference locations 88 is determined by the following method: determine the population characteristics driving demand 90; determine the trade area extent method for the facility study category 92; determine the spatial weighting of the population in the trade area 94; apply the spatial weighting to the population characteristics in the trade area 96; and add the results for each facility in the select reference location to determine demand 98. Supply for the reference locations 100 is determined by the following method: apply the weighting method to each facility in the select reference location 102; apply the spatial weighting method to each facility in the select reference location 104; and add the results for each facility in the select reference location to determine supply 106. Determine the relationship between supply and demand for the facilities in the select reference location by relating the summed results of supply and demand 108. This information is used to determine the relationship between supply and the development potential for an area 110. A map can then be generated of the overall development potential of the study area or the areas around any specific geographic points 112 by calculating the supply and demand for each geographic point 114, determining the development potential 116, and noting the development potential of the study area onto the map 118. From the information identified, the user selects points of interest from the map 120 and an output of the development potential for each point of interest is generated 122. The development potential of each point of interest may be adjusted by other factors to create an adjusted development potential for each point of interest 124.

Suitable facilities in the facility study categories for an area or one or more geographic points that fulfill the overall development potential can be determined 126. To test individual facilities within a category 128, the supply and demand for each facility is studied 130. The supply and demand for each point of interest is tested 132. If it is determined that the supply/demand for a facility is acceptable, the facility is accepted as a candidate for potential development 134. Any accepted facility is added to the adjusted developmental potential for the area or each point of interest 136.

To further determine development potential, examples of analogous existing developments are identified 138. Data regarding existing developments are selected where some or all of the following are true 140: demand in the existing development is about the same demand in the area or point of interest 142; the facility in the existing development is similar to the facility being studied 144; the supply in the existing developing is similar to the supply in the area or point of interest of the facility being studied 146; the demand in the existing developing is similar to the demand in the area or point of interest of the facility being studied 148; and where any other characteristics are similar between the existing development and the facility being studies 150. The relevant characteristics of the selected existing development are stated 152 as to supply characteristics 154, demand characteristics 156, physical characteristics 158, and sales information 160.

The feature of the invention is then used to identify a development plan 162 which shows a map of the potential development area 164, the potential numbers for development 166, any adjusted development numbers 168, support for the development plan 168, accepted facilities for each point of interest 170, and locations for new facilities 172.

The following Example is offered to illustrate, but not limit the process and system of the present invention.

### EXAMPLE 1

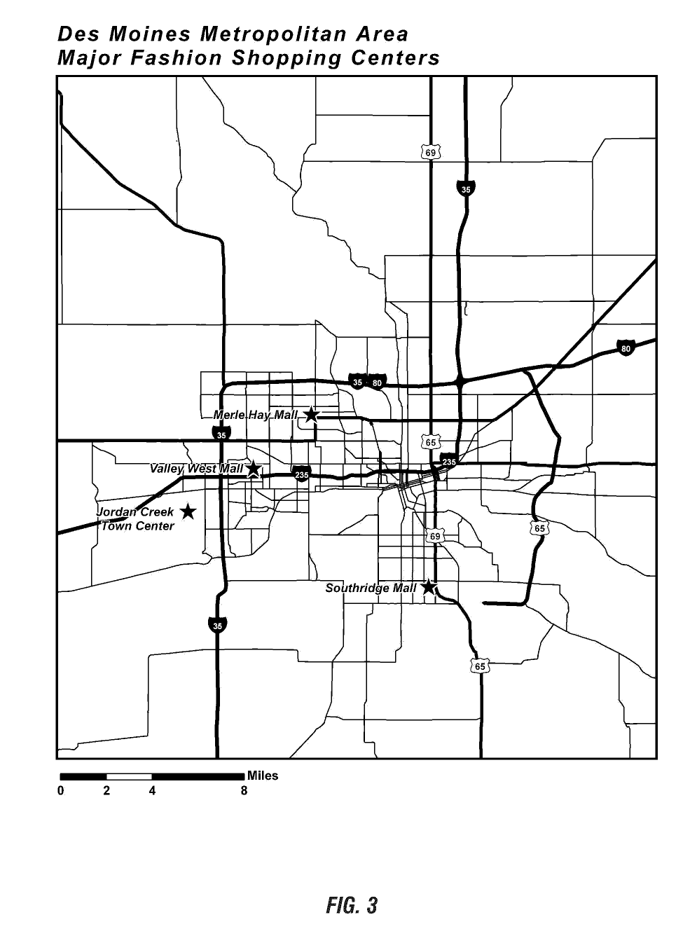

A geographic point is selected within a region for analysis for new retail or related real estate development. Within the region surrounding the geographic point, the supply of retail or related real estate is determined FIG. 3. In determining supply of retail or related real estate, the location by address, longitude and latitude, or other locator of each existing retail store or related real estate entity is identified in the region surrounding the geographic point. Retail and related real estate entities are identified by specific name. In the case of retail, such as fashion retail, each named retail store is assigned a quality index which indicates its drawing strength to a certain household demographic. The stronger the quality index, the stronger the customer drawing strength from affluent households or other economic indicators. Similar indicators are used for related real estate, other than retail, to determine the drawing power of a particular business. The distance between the geographic point and existing retail locations or related real estate locations is calculated to determine if a potential development site would compete with existing retail stores or related real estate in the general geographic area. In the case of retail stores, such as fashion retail stores, an adjusted quality index for each existing fashion retail store location is determined based on the quality index of the particular store and the distance between the geographic point and the competing retail stores. The adjusted quality indices are added together to determine the adjusted quality index for the geographic region. This identifies supply of retail shop space in the geographic area. This same methodology is used for related real estate.

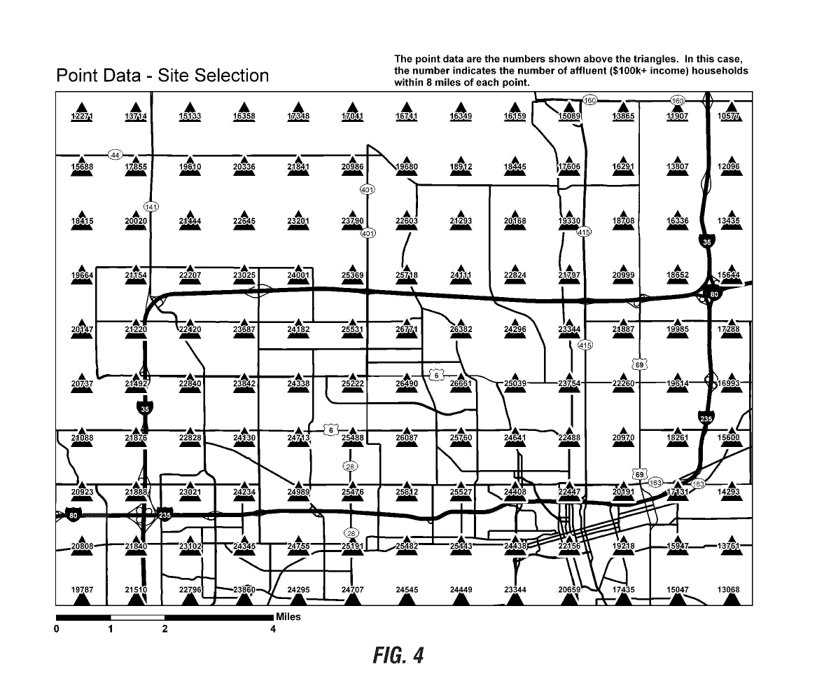

To determine demand within the geographic region surrounding the selected geographic point, the number of affluent households or other economic indicator is identified in the surrounding geographic area. Different indicators or a stratification of an indicator may also be used to determine demand. For example, one indicator to determine affluent households is the number of households with an annual income of $100,000 or more FIG. 4. The annual income threshold can be stratified to determine the number of households with an annual income of $125,000 or more; $150,000 or more; and so forth. The calculated demand is determined by the number of households with an annual income over a certain level and is then compared to the supply of retail or related real estate in the geographic region. For purposes of finding an optimal location, this method can be extended to analyze multiple points within a wider geographic region.

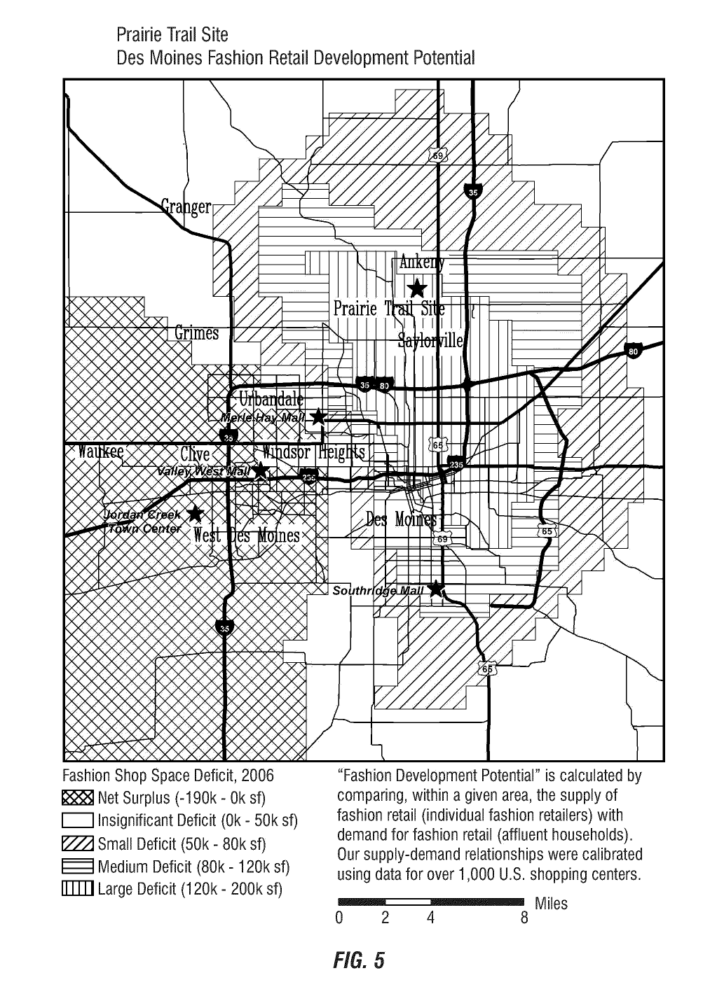

The use of these demographics provides data to the prospective developer relative to supply of retail or related real estate within a geographic region and, in that same region, the demand for the same type of retail or related real estate. If supply exceeds demand for retail or related real estate, the geographic region is not likely suitable for development. If demand exceeds supply, the geographic region may be attractive for further retail or related real estate development. To portray the pattern of retail supply and demand within the wider geographic region, supply and demand is mapped to identify potential real estate development opportunities. The mapping of the supply and demand patterns results in the identification of relative strengths of the prospective development sites. An example of the mapping of retail supply versus demand for a particular area is shown in FIG. 5.

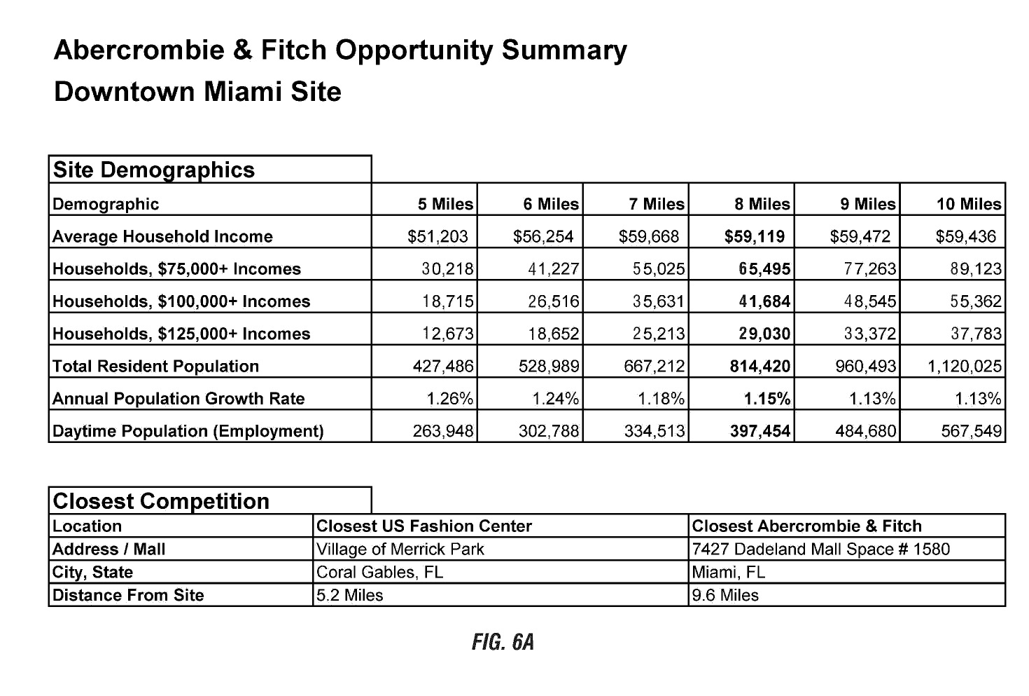

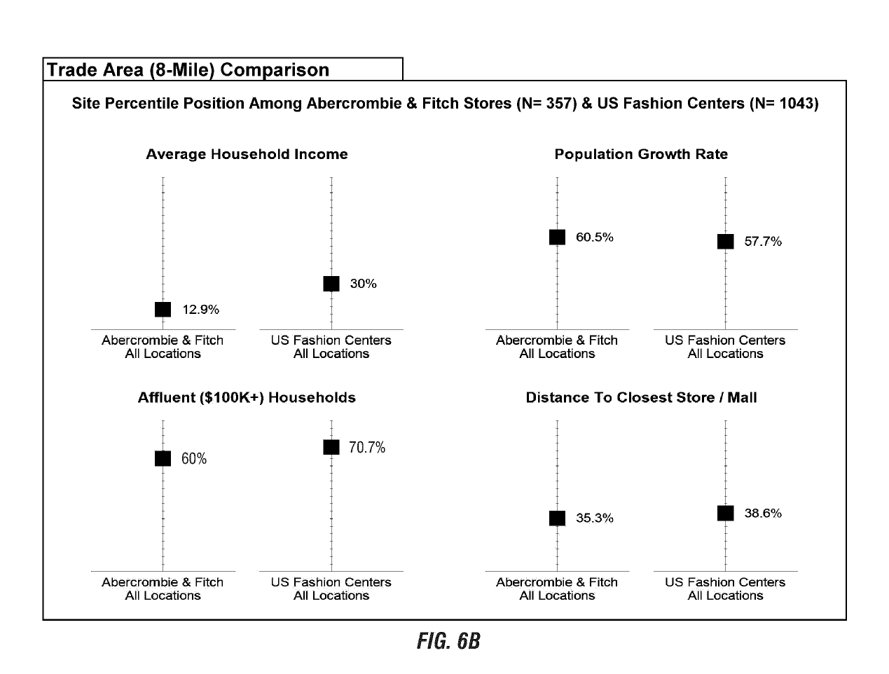

The present invention also describes a method for determining a prospective retail or related real estate tenant for a geographic site FIG. 6. In this aspect of the invention, a geographic site is predetermined. A prospective tenant, retail or related real estate, is identified for the site. The population characteristics of the same named tenants are identified as that of the prospective tenant. Population characteristics of the surrounding population and households of the geographic site are identified. The demographic data of the same named tenants in the retailer's chain is compared with the population characteristics of the proposed geographic site to determine if the profile of the geographic site's population characteristics falls within acceptable ranges for the same named tenants as that of the prospective tenant for the site. All distances between existing stores in the retailer's chain are calculated. The distance from the predetermined geographic site to the closest existing same named store in the retailer's chain is compared with those distances among existing store location of the same named retailers. This comparison assesses the economic potential of locating the prospective tenant at that specific geographic site based on population characteristics and distance comparisons.

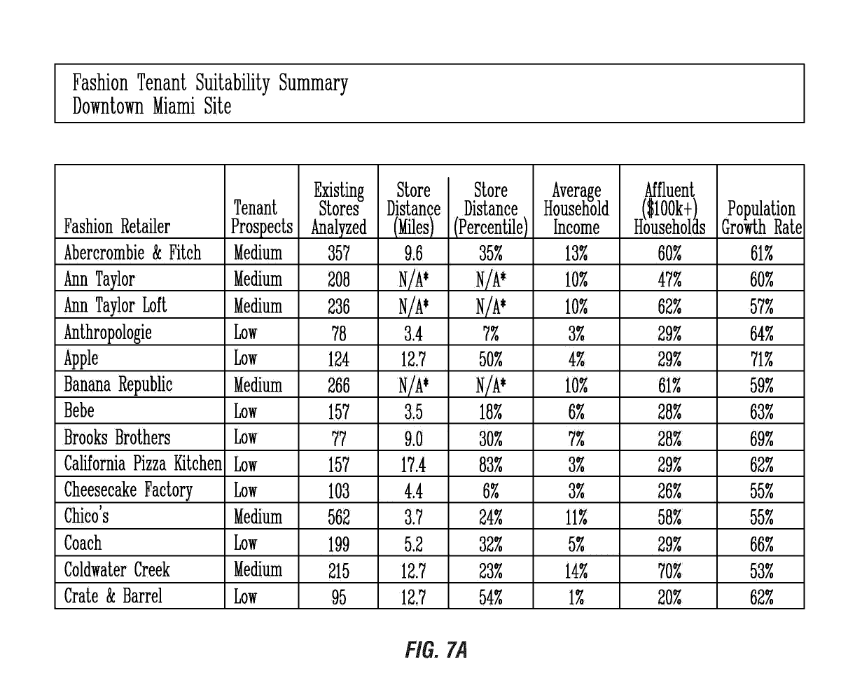

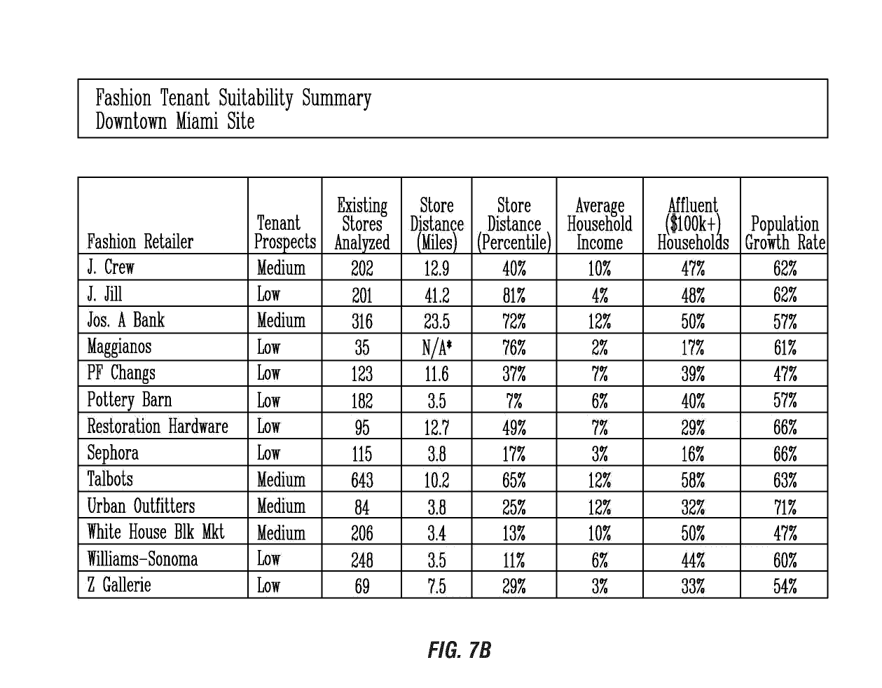

The present invention also describes an analog method for identifying a retail tenant suitability summary for a particular site by analyzing the existing store locations of each of the potential retailers as to total number of retailers, distance between like retailers, average household income in the geographic area around each retail location, the number of affluent households, and the population growth rate in the respective geographic areas FIG. 7.

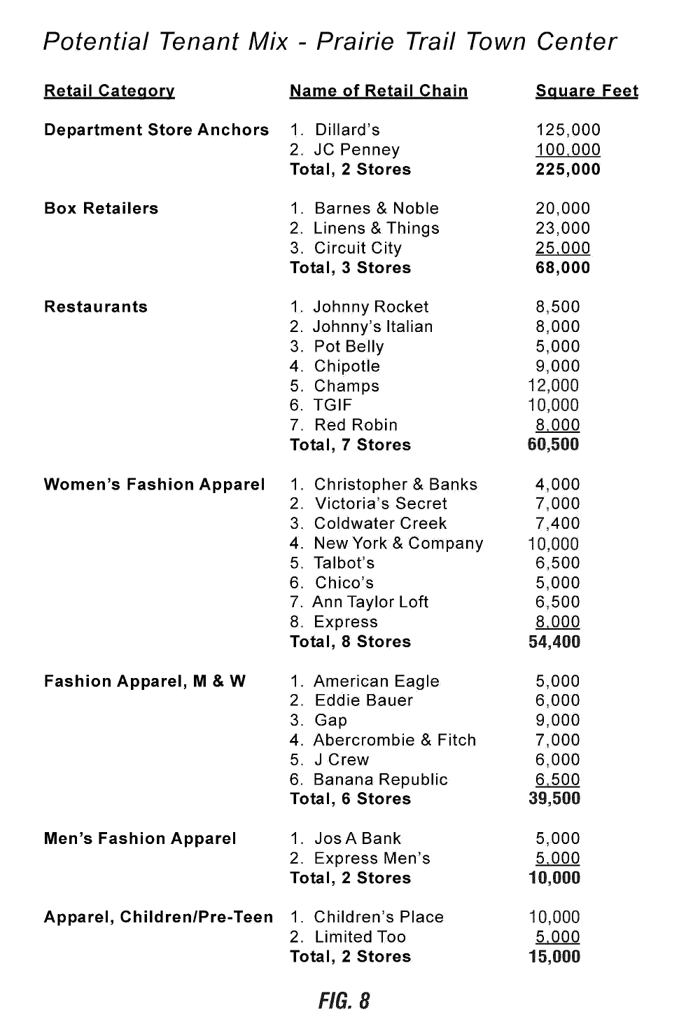

The present invention also describes an analog method to identify retail tenant mix recommendations for a particular site by analyzing retail categories, retail chains, square footage of the retail chain, and other factors FIG. 8.

The present invention also describes an analog method for identifying existing retail developments consisting of the development potential identified in the site selection methodology and tenants like those identified in the tenant suitability methodology. Further, analogs are selected according to population characteristics and retail supply conditions of existing retail developments within a geographic region or nationally.

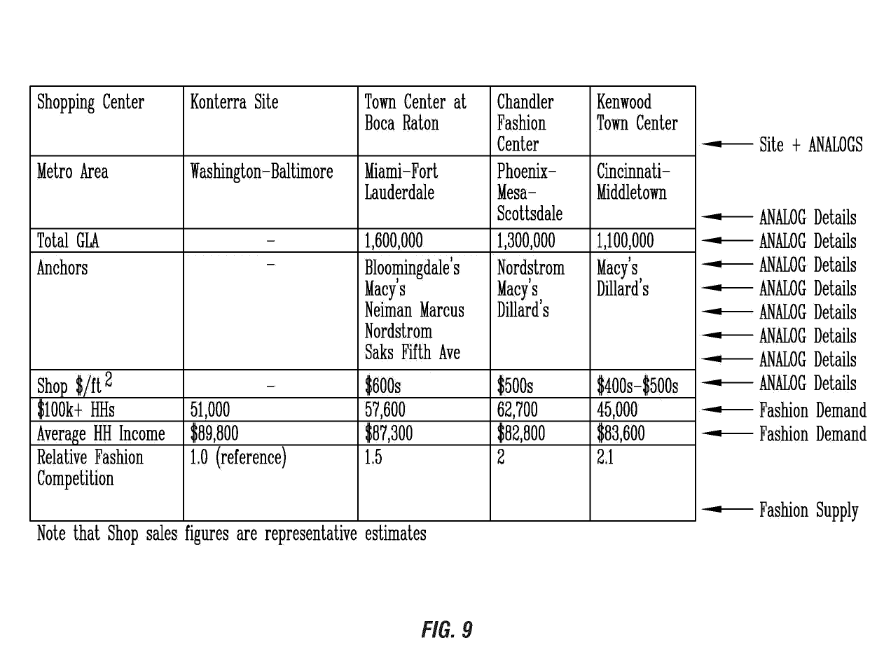

The present invention also describes an analog method for identifying existing retail centers that have trade areas that are similar with respect to their populations and affluent households FIG. 9.

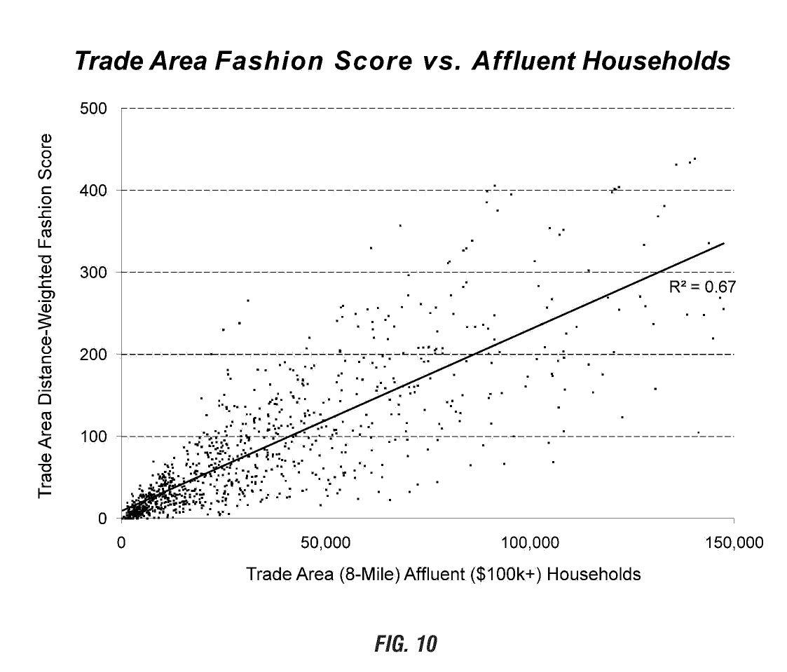

The present invention also describes an analog method for identifying trade area fashion scores or trade area quality indices plotted against affluent households or other geographic economic indicators FIG. 10.

The method of the present invention of evaluating locations for retail or related real estate development is novel in that a location's actual versus normative status regarding supply versus demand conditions by category of retail store or related real estate to systematically and objectively evaluate opportunities to develop new retail stores or businesses at a specific location. In doing so, it comprises an integrated location evaluation system consisting of four components: (1) a site development potential component; (2) a development potential mapping component; (3) a tenant suitability component; and (4) a sales forecasting component.

In describing representative embodiments of the present invention, the specification may have presented the method and system of the present invention as a particular sequence of steps. However, to the extent that the method and system does not rely on the particular order of steps set forth herein, the method and system should not be limited to the particular sequence of steps described. As one of ordinary skill in the art would appreciate, other sequences of steps may be possible. Therefore, the particular order of the steps set forth in the specification should not be construed as limiting the scope of the invention.

The foregoing disclosure of embodiments of the present invention has been presented for purposes of illustration and description. It is not intended to be exhaustive or to limit the invention to the precise forms disclosed. Many variations and modifications of the embodiment described herein will be obvious to one of ordinary skill in the art in light of the above disclosures. The subject matter of the invention includes all novel and non-obvious combinations and subcombinations of the various elements, features, functions, steps and/or methods disclosed herein.

We claim:

1. A method of determining a site for the development of prospective retail store space, comprising:
selecting a geographic point for prospective retail store locations;
determining existing retail store locations in the geographic region surrounding said geographic point;
determining populations characteristics of existing households in said geographic region;
analyzing existing retail store locations and said population characteristics of existing households; and
identifying a new area of interest within said geographic region for development of prospective retail store locations.

2. The method of claim 1 wherein existing retail store locations are identified within a certain distance from said new area of interest.

3. The method of claim 2 wherein supply of retail store locations is determined by identifying existing retail store locations within a certain distance from said new area of interest.

4. The method of claim 1 wherein said existing households are within a certain distance from said new area of interest.

5. The method of claim 4 wherein said existing households have a minimum annual household income.

6. The method of claim 5 wherein demand for retail store space is determined by the number of households within a certain distance from said new area of interest have a minimum annual household income.

7. The method of claim 1 wherein said existing retail store locations are analyzed with respect to the number of existing households in said new area of interest.

8. A method of determining a site for the development of prospective related real estate, comprising:
selecting a geographic point for prospective related real estate locations;
determining existing related real estate locations in the geographic region surrounding said geographic point;
determining population characteristics of existing households in said geographic region;
analyzing existing related real estate locations and said population characteristics of existing households; and
identifying a new area of interest within geographic region for development of prospective related real estate locations.

9. The method of claim 8 wherein existing related real estate locations are identified within a certain distance from said new area of interest.

10. The method of claim 9 wherein supply of related real estate locations is determined by identifying existing related real estate locations within a certain distance from said new area of interest.

11. The method of claim 8 wherein said existing households are within a certain distance from said new area of interest.

12. The method of claim 11 wherein said existing households have a minimum annual household income.

13. The method of claim 12 wherein demand for related real estate is determined by the number of households within a certain distance from said new area of interest have a minimum annual household income.

14. The method of claim 8 wherein said existing related real estate locations are analyzed with respect to the number of existing households in said new area of interest.

15. A method of determining a prospective retail tenant for a geographic site, comprising:
identifying a prospective retail tenant;
identifying population characteristics for retail tenants of the same name as that of the prospective retail tenant;
determining population characteristics of existing households in said geographic site;
analyzing said population characteristics for existing retail tenants and demographics of existing households; and
assessing the potential of locating prospective retail tenant at said geographic site.

16. The method of claim 15 wherein said existing retail tenants are the same named retail store as the prospective retail tenant.

17. The method of claim 15 wherein said existing households are within a certain distance of said geographic site of prospective retail tenant location.

18. The method of claim 15 wherein existing households have a minimum annual household income.

19. The method of claim 15 wherein said population characteristics for existing retail tenants are analyzed with respect to said population characteristics of existing households within a certain distance of said geographic site of prospective retail tenant.

20. The method of claim 19 wherein said analysis compares population characteristics of said prospective retail tenant located at said new geographic site to the population characteristics of the same named existing retail tenants.

21. A method of determining a prospective related real estate tenant for a geographic site, comprising:
identifying a prospective related real estate tenant;
identifying the population characteristics for related real estate tenants of the same name as that of the prospective related real estate tenant;
determining the population characteristics of existing households in said geographic site;
analyzing said population characteristics for existing related real estate tenants and the population characteristics of existing households; and
assessing potential of locating prospective related real estate tenant at said geographic site.

22. The method of claim 21 wherein said existing related real estate tenants are the same named related real estate stores as the prospective related real estate tenant.

23. The method of claim 21 wherein said existing households are within a certain distance of said geographic site of prospective related real estate tenant location.

24. The method of claim 21 wherein existing households have a minimum annual household income.

25. The method of claim 21 wherein said population characteristics for existing related real estate tenants are analyzed with respect to said population characteristics of existing households within a certain distance of said geographic site of prospective retail or related real estate tenant.

26. The method of claim 25 wherein said analysis compares said population characteristics of said prospective related real estate tenant located at said new geographic site to said population characteristics of the same named existing related real estate tenants.

27. A method of identifying existing retail developments, comprising:
identifying the retail development potential identified using the site selection methodology;
identifying the tenant like those identified in the tenant suitability methodology; and
selecting analogs according to population characteristics and retail supply conditions of existing retail developments.
